(19) United States
(12) Patent Application Publication
(10) Pub. No.: US 2024/0064802 A1
(43) Pub. Date: Feb. 22, 2024

(54) METHOD AND DEVICE FOR ACCESSING UNLICENSED CHANNEL

(71) Applicant: Beijing Xiaomi Mobile Software Co., Ltd., Beijing (CN)

(72) Inventor: Ting FU, Beijing (CN)

(21) Appl. No.: 18/260,589

(22) PCT Filed: Jan. 8, 2021
(86) PCT No.: PCT/CN2021/070855

§ 371 Date: Jul. 6, 2023

(51) Int. Cl. H04W 74/08; H04W 16/14; H04L 5/00

(52) U.S. Cl. CPC H04W 74/0808; H04W 16/14; H04L 5/0055

(57) ABSTRACT

A method for accessing an unlicensed channel includes: a transmitter device determining an assessment manner of performing listen before talk (LBT) assessment on an unlicensed channel, where the assessment manner includes a first manner or a second manner, the first manner includes the transmitter device performing the LBT assessment to obtain a first assessment result, and the second manner includes the transmitter device performing the LBT assessment to obtain the first assessment result and acquiring a second assessment result of the LBT assessment performed by a receiver device; and assessing the unlicensed channel according to the determined assessment manner.

### BACKGROUND

Radio spectrum resources are a kind of limited and non-renewable natural resources. Hence, every country has a special management agency for radio spectrum and issues special policies and regulations to achieve unified planning and management of the radio spectrum.

### SUMMARY

The disclosure provides a method for accessing an unlicensed channel and a device.

According to a first aspect of an example of the disclosure, a method for accessing an unlicensed channel is provided, applied to a transmitter device, and including:
determining an assessment manner of performing listen before talk (LBT) assessment on the unlicensed channel, where the assessment manner includes a first manner or a second manner, the first manner includes a transmitter device performing the LBT assessment to obtain a first assessment result, and the second manner includes the transmitter device performing the LBT assessment to obtain the first assessment result and acquiring a second assessment result of the LBT assessment performed by a receiver device; and
assessing the unlicensed channel according to the determined assessment manner.

According to a second aspect of an example of the disclosure, a method for accessing an unlicensed channel is provided, applied to a receiver device, and including:
sending assistance information to a transmitter device, so that the transmitter device determines an assessment manner according to the assistance information, where
the assessment manner is an assessment manner for assessing accessing the unlicensed channel; and
the assessment manner includes a first manner or a second manner, the first manner includes the transmitter device performing LBT assessment to obtain a first assessment result, and the second manner includes the transmitter device performing the LBT assessment to obtain the first assessment result and acquiring a second assessment result of the LBT assessment performed by the receiver device.

According to a third aspect of an example of the disclosure, a transmitter device is provided, including:
a processor; and
a memory, configured to store executable instructions of the processor, where
the processor is configured to: determine an assessment manner of performing listen before talk (LBT) assessment on the unlicensed channel, wherein the assessment manner comprises a first manner or a second manner, the first manner comprises a transmitter device performing the LBT assessment to obtain a first assessment result, and the second manner comprises the transmitter device performing the LBT assessment to obtain the first assessment result and acquiring a second assessment result of the LBT assessment performed by a receiver device; and assess the unlicensed channel according to the determined assessment manner.

It is to be understood that the above general description and the following detailed description are merely for example and explanatory, and cannot limit the disclosure.

### BRIEF DESCRIPTION OF THE DRAWINGS

Accompanying drawings illustrated here are used for providing a further understanding of the examples of the disclosure, and constitute a part of the present application. The schematic instances and their explanations of the examples of the disclosure are used for explaining the examples of the disclosure and do not constitute an improper limitation on the examples of the disclosure. In the accompanying drawings:
the accompanying drawings here, which are incorporated in and constitute a part of this specification, illustrate examples consistent with the examples of the disclosure and together with the specification, serve to explain the principles of the examples of the disclosure.

FIG. 1 is a flowchart of a method for accessing an unlicensed channel shown according to an example.

FIG. 2 is a flowchart of a method for accessing an unlicensed channel shown according to an example.

FIG. 3 is a flowchart of a method for accessing an unlicensed channel shown according to an example.

FIG. 4 is a structural diagram of an apparatus for accessing an unlicensed channel shown according to an example.

FIG. 5 is a structural diagram of an apparatus for accessing an unlicensed channel shown according to an example.

FIG. 6 is a structural diagram of an apparatus for accessing an unlicensed channel shown according to an example.

FIG. 7 is a structural diagram of an apparatus for accessing an unlicensed channel shown according to an example.

### DETAILED DESCRIPTION

The disclosure relates to the technical field of wireless communications, in particular to a method and apparatus for accessing an unlicensed channel, a device and a storage medium.

Most of spectrum management in various countries uses a fixed spectrum allocation strategy, that is, spectrum resources are managed by government competent departments and allocated to fixed licensed users, which can ensure that excessive mutual interference are avoided between users and the spectrum resources are utilized better. The spectrum resources may be divided into two categories, namely a licensed spectrum and an unlicensed spectrum.

The licensed spectrum is strictly limited and protected, and allowed to be accessed by the licensed users and their compliant devices.

Although an unlicensed frequency band is rich in resource, in order to ensure fair coexistence between different radio access technologies (RATs) using the frequency band, a listen before talk (LBT) technology based on clear channel assessment (CCA) is introduced, and the introduction of LBT into new radio based unlicensed access (NR-U) is an important way to ensure fair coexistence.

Examples of the disclosure are further illustrated with reference to accompanying drawings and specific implementations.

Examples will be illustrated in detail here, and instances of which are represented in the accompanying drawings. When the following description refers to the accompanying drawings, the same number in the different accompanying drawings represents the same or similar elements unless otherwise indicated. The implementations described in the following examples do not represent all implementations consistent with the examples of the disclosure. On the contrary, they are merely examples of an apparatus and method consistent with some aspects of the disclosure as detailed in the appended claims.

In some possible scenarios, a sending end performs LBT assessment on an unlicensed channel, and data are sent on the unlicensed channel if an assessment result is that channel interference is small. However, the channel interference at a receiving end is large, and after receiving the data, the receiving end cannot correctly demodulate the received data.

Hence, a receiving end assisted assessment manner is proposed, specifically: the sending end performs the LBT assessment on the unlicensed channel to obtain a first assessment result, the receiving end performs the LBT assessment on the unlicensed channel to obtain a second assessment result, and the receiving end sends the second assessment result to the sending end. After receiving the second assessment result, the sending end performs a comprehensive evaluation according to the first assessment result and the second assessment result, and determines whether to access the unlicensed channel according to a comprehensive evaluation result. After accessing the unlicensed channel, the data are sent through the unlicensed channel.

By using the receiving end assisted assessment manner, a case that an interference level of the unlicensed channel assessed by the receiving end is inconsistent with an interference level of the unlicensed channel assessed by the LBT assessment at the sending end may be assessed in advance.

A sender unilateral assessment manner is less in signaling overhead and low in assessment accuracy for the interference level. The receiver assisted assessment manner is more in signaling overhead and high in assessment accuracy for the interference level. Hence, there is a need to switch between the two assessment manners.

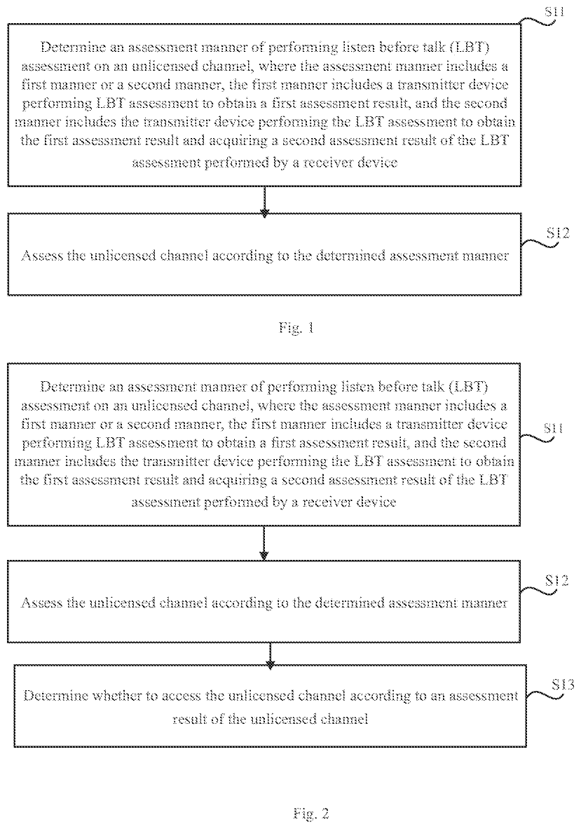

An example of the disclosure provides a method for accessing an unlicensed channel, applied to a transmitter device. This transmitter device is either a base station device or user equipment. Referring to FIG. 1, FIG. 1 is a flowchart of a method for accessing an unlicensed channel shown according to an example. As shown in FIG. 1, the method includes:

step S11, an assessment manner of performing listen before talk (LBT) assessment on the unlicensed channel is determined, where the assessment manner includes a first manner or a second manner, the first manner includes a transmitter device performing the LBT assessment to obtain a first assessment result, and the second manner includes the transmitter device performing the LBT assessment to obtain the first assessment result and acquiring a second assessment result of the LBT assessment performed by a receiver device; and

step S12, the unlicensed channel is assessed according to the determined assessment manner.

In an implementation, the first manner may be, for example, referred to as a sender unilateral assessment manner, while the second manner may be, for example, referred to as a receiver assisted assessment manner.

In this example, the transmitter device can assess the unlicensed channel by using different manners, that is, same can assess the unlicensed channel by using the first manner, and can also assess the unlicensed channel by using the second manner. Both manners have their own strengths, for example, the transmitter device can save signaling overheads when using the first manner, and can improve assessment accuracy of an interference level when using the second manner. The transmitter device switches between the two assessment manners, and can use different assessment manners in different application scenarios, so as to meet different assessment requirements.

An example of the disclosure provides a method for accessing an unlicensed channel, applied to a transmitter device. This transmitter device is either a base station device or user equipment. Referring to FIG. 2, FIG. 2 is a flowchart of a method for accessing an unlicensed channel shown according to an example. As shown in FIG. 2, the method includes:

step S11, an assessment manner of performing listen before talk (LBT) assessment on the unlicensed channel is determined, where the assessment manner includes a first manner or a second manner, the first manner includes a transmitter device performing the LBT assessment to obtain a first assessment result, and the second manner includes the transmitter device performing the LBT assessment to obtain the first assessment result and acquiring a second assessment result of the LBT assessment performed by a receiver device;
step S12, the unlicensed channel is assessed according to the determined assessment manner; and
step S13, whether to access the unlicensed channel is determined according to the assessment result of the unlicensed channel.

Step S13 includes any of the following modes:
determining to access the unlicensed channel according to the assessment result of the unlicensed channel, or
determining not to access the unlicensed channel according to the assessment result of the unlicensed channel.

In an example, in response to an interference level corresponding to the assessment result of the unlicensed channel being less than or equal to a first threshold value, it is determined to access the unlicensed channel; and in response to the interference level corresponding to the assessment result of the unlicensed channel being greater than or equal to the first threshold value, it is determined not to access the unlicensed channel

In an implementation, the first manner may be, for example, referred to as a sender unilateral assessment manner, while the second manner may be, for example, referred to as a receiver assisted assessment manner.

In this example, the transmitter device can assess the unlicensed channel by using different manners, that is, same can assess the unlicensed channel by using the first manner, and can also assess the unlicensed channel by using the second manner. Both manners have their own strengths, for example, the transmitter device can save signaling overheads when using the first manner, and can improve assessment accuracy of an interference level when using the second manner. The transmitter device switches between the two assessment manners, and can use different assessment manners in different application scenarios, so as to determine whether to be capable of accessing the unlicensed channel.

An example of the disclosure provides a method for accessing an unlicensed channel, applied to a transmitter device. This transmitter device is either a base station device or user equipment. The method includes:
determining an assessment manner according to a hybrid automatic repeat request-ACK (HARQ-ACK) feedback result of a receiver device.

In an implementation, it may be considered that in the aforementioned example as shown in FIG. 1 or FIG. 2, determining the assessment manner of performing the LBT assessment on the unlicensed channel in step S11 includes: determining the assessment manner according to the hybrid automatic repeat request-ACK (HARQ-ACK) feedback result of the receiver device.

In this example, the HARQ-ACK feedback result of the receiver device is used as a reference parameter to determine the assessment manner. In response to that the HARQ-ACK feedback result of the receiver device represents that an interference level of the unlicensed channel of a receiver is large, a second manner is used; and in response to that the HARQ-ACK feedback result of the receiver device represents that the interference level of the unlicensed channel of the receiver is small, a first manner is used.

In an implementation, the present method further includes: a configuration signaling is received, where the configuration signaling contains at least one of the following parameters:
information used for indicating a first time interval, or
information used for indicating a first threshold value.

In an example, determining the assessment manner according to the HARQ-ACK feedback result of the receiver device includes: determining, in response to a proportion of NACK received within the first time interval being greater than or equal to the first threshold value, to perform the LBT assessment on the unlicensed channel by using the second manner.

In an example, determining the assessment manner according to the HARQ-ACK feedback result of the receiver device includes: determining, in response to the proportion of NACK received within the first time interval being less than or equal to the first threshold value, to perform the LBT assessment on the unlicensed channel by using the first manner.

In an example, the first time interval may be, for example, 1000 milliseconds.

In an example, the first threshold value may be, for example, 30%.

An example of the disclosure provides a method for accessing an unlicensed channel, applied to a transmitter device. This transmitter device is either a base station device or user equipment. The method includes:
determining, in response to receiving an assistance opening request of a receiver device, to perform LBT assessment on the unlicensed channel by using a second manner; and
assessing the unlicensed channel according to the determined assessment manner.

In an implementation, the receiver device obtains a second assessment result by performing clear channel assessment, and determines whether to send an assistance opening request according to the second assessment result and a second threshold value. In an example, in response to the second assessment result being greater than or equal to the second threshold value, the assistance opening request is sent. In another example, in response to the second assessment result being less than or equal to the second threshold value, the assistance opening request is not sent.

In an implementation, it may be considered that in the aforementioned example as shown in FIG. 1 or FIG. 2, determining the assessment manner of performing the LBT assessment on the unlicensed channel in step S11 includes: determining, in response to receiving the assistance opening request of the receiver device, to perform the LBT assessment on the unlicensed channel by using the second manner.

In this example, by using a manner that the receiver device determines whether to actively send the assistance opening request according to a clear channel assessment result, after receiving the assistance opening request, the transmitter device determines to perform the LBT assessment on the unlicensed channel by using the second manner. The transmitter device selects the second manner according to indication of the receiver device, so that an operation of selecting the second manner conforms to a channel interference situation of the receiver device.

An example of the disclosure provides a method for accessing an unlicensed channel, applied to a transmitter device. This transmitter device is either a base station device or user equipment. The method includes:
determining, in response to receiving an assistance terminating request sent by a receiver device, to perform LBT assessment on the unlicensed channel by using a first manner; and
assessing the unlicensed channel according to the determined assessment manner.

In an implementation, the receiver device obtains a second assessment result by performing clear channel assessment, and determines to send the assistance terminating request according to the second assessment result and a second threshold value. In an example, when the second assessment result is less than or equal to the second threshold value, the assistance terminating request is sent.

In an implementation, it may be considered that in the aforementioned example as shown in FIG. 1 or FIG. 2, determining the assessment manner of performing the LBT assessment on the unlicensed channel in step S11 includes: determining, in response to receiving the assistance terminating request sent by the receiver device, to perform the LBT assessment on the unlicensed channel by using a first manner.

In this example, by using a manner that the receiver device determines whether to actively send the assistance terminating request according to a clear channel assessment result, after receiving the assistance terminating request, the transmitter device determines to perform the LBT assessment on the unlicensed channel by using the first manner. The transmitter device selects the first manner according to indication of the receiver device, so that an operation of selecting the first manner conforms to a channel interference situation of the receiver device.

An example of the disclosure provides a method for accessing an unlicensed channel, applied to a transmitter device. This transmitter device is either a base station device or user equipment. The method includes:
determining, in response to receiving a configuration signaling, an assessment manner of performing LBT assessment on the unlicensed channel according to the configuration signaling; and
assessing the unlicensed channel according to the determined assessment manner.

In an implementation, the configuration signaling includes an indication field for indicating the selection of a first manner, and/or an indication field for indicating the selection of a second manner.

In an implementation, it may be considered that in the aforementioned example as shown in FIG. 1 or FIG. 2, determining the assessment manner of performing the LBT assessment on the unlicensed channel in step S11 includes: determining, in response to receiving the configuration signaling, the assessment manner of performing the LBT assessment on the unlicensed channel according to the configuration signaling.

In this example, the configuration signaling is received from the receiver device, and the assessment manner of performing the LBT assessment on the unlicensed channel is determined according to the configuration signaling.

An example of the disclosure provides a method for accessing an unlicensed channel, applied to a transmitter device. This transmitter device is either a base station device or user equipment. The method includes:
determining, in response to receiving a media access control (MAC) signaling or a radio resource control (RRC) signaling, an assessment manner of performing LBT assessment on the unlicensed channel by using a second manner according to preset fields of the MAC signaling or RRC signaling;
assessing the unlicensed channel according to the determined assessment manner.

In an implementation, it may be considered that in the aforementioned example as shown in FIG. 1 or FIG. 2, determining the assessment manner of performing the LBT assessment on the unlicensed channel in step S11 includes: determining, in response to receiving the media access control (MAC) signaling or the radio resource control (RRC) signaling, the assessment manner of performing the LBT assessment on the unlicensed channel by using the second manner according to preset fields of the MAC signaling or RRC signaling.

In this example, the media access control (MAC) signaling or the radio resource control (RRC) signaling is received from the receiver device, and indication for using the second manner is learned from the signaling.

An example of the disclosure provides a method for accessing an unlicensed channel, applied to a transmitter device. This transmitter device is either a base station device or user equipment. The method includes:
determining, in response to receiving an MAC signaling or an RRC signaling, an assessment manner of performing LBT assessment on the unlicensed channel by switching from a first manner to a second manner according to preset fields of the MAC signaling or RRC signaling; and
assessing the unlicensed channel according to the determined assessment manner.

In an implementation, it may be considered that in the aforementioned example as shown in FIG. 1 or FIG. 2, determining the assessment manner of performing the LBT assessment on the unlicensed channel in step S11 includes: determining, in response to receiving the MAC signaling or the RRC signaling, the assessment manner of performing the LBT assessment on the unlicensed channel by switching from the first manner to the second manner according to the preset fields of the MAC signaling or RRC signaling.

In this example, the media access control (MAC) signaling or the radio resource control (RRC) signaling is received from the receiver device, and indication for switching from the first manner to the second manner is learned from the signaling.

An example of the disclosure provides a method for accessing an unlicensed channel, applied to a transmitter device. This transmitter device is either a base station device or user equipment. The method includes:
determining, in response to receiving an MAC signaling or an RRC signaling, an assessment manner of performing LBT assessment on the unlicensed channel by using a first manner according to preset fields of the MAC signaling or RRC signaling; and
assessing the unlicensed channel according to the determined assessment manner.

In an implementation, it may be considered that in the aforementioned example as shown in FIG. 1 or FIG. 2, determining the assessment manner of performing the LBT assessment on the unlicensed channel in step S11 includes: determining, in response to receiving the MAC signaling or the RRC signaling, the assessment manner of performing the LBT assessment on the unlicensed channel by using the first manner according to the preset fields of the MAC signaling or RRC signaling.

In this example, the media access control (MAC) signaling or the radio resource control (RRC) signaling is received from the receiver device, and indication for using the first manner is learned from the signaling.

An example of the disclosure provides a method for accessing an unlicensed channel, applied to a transmitter device. This transmitter device is either a base station device or user equipment. The method includes:
determining, in response to receiving an MAC signaling or an RRC signaling, an assessment manner of performing LBT assessment on the unlicensed channel by switching from a second manner to a first manner according to preset fields of the MAC signaling or RRC signaling; and
assessing the unlicensed channel according to the determined assessment manner.

In an implementation, it may be considered that in the aforementioned example as shown in FIG. 1 or FIG. 2, determining the assessment manner of performing the LBT assessment on the unlicensed channel in step S11 includes: determining, in response to receiving the MAC signaling or the RRC signaling, the assessment manner of performing the LBT assessment on the unlicensed channel by switching from the second manner to the first manner according to the preset fields of the MAC signaling or RRC signaling.

In this example, the media access control (MAC) signaling or the radio resource control (RRC) signaling is received from the receiver device, and indication for switching from the second manner to the first manner is learned from the signaling.

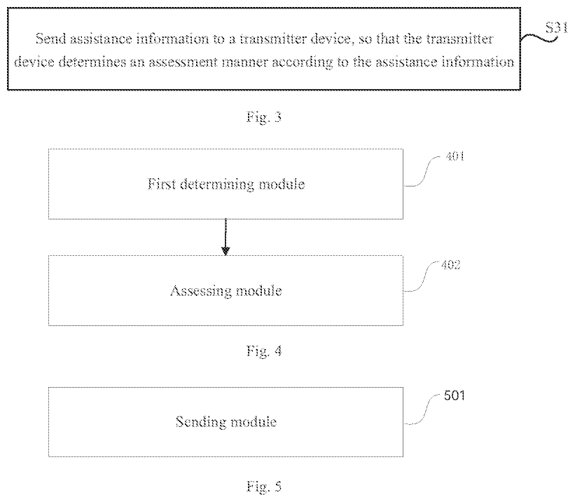

An example of the disclosure provides a method for accessing an unlicensed channel, applied to a receiver device. This receiver device is either a base station device or user equipment. Referring to FIG. 3, FIG. 3 is a flowchart of a method for accessing an unlicensed channel shown according to an example. As shown in FIG. 3, the method includes:

step S31, assistance information is sent to a transmitter device, so that the transmitter device determines an assessment manner according to the assistance information, where
the assessment manner is an assessment manner for assessing accessing the unlicensed channel; and
the assessment manner includes a first manner or a second manner, the first manner includes the transmitter device performing LBT assessment to obtain a first assessment result, and the second manner includes the transmitter device performing the LBT assessment to obtain the first assessment result and acquiring a second assessment result of the LBT assessment performed by the receiver device.

In this example, the receiver device sends the assistance information to the transmitter device, so that the transmitter device determines the assessment manner according to the assistance information, and thus the transmitter device can assess the unlicensed channel by using different manners, that is, same can assess the unlicensed channel by using the first manner, and can also assess the unlicensed channel by using the second manner. Both manners have their own strengths, for example, the transmitter device can save signaling overheads when using the first manner, and can improve assessment accuracy of an interference level when using the second manner. The transmitter device switches between the two assessment manners, and can use different assessment manners in different application scenarios, so as to meet different assessment requirements.

An example of the disclosure provides a method for accessing an unlicensed channel, applied to a receiver device. This receiver device is either a base station device or user equipment. The method includes:
sending assistance information to a transmitter device, so that the transmitter device determines an assessment manner according to the assistance information, where the assistance information includes an assistance opening request, so that the transmitter device determines to perform LBT assessment on the unlicensed channel by using a second manner.

The second manner includes the transmitter device performing the LBT assessment to obtain a first assessment result and acquiring a second assessment result of the LBT assessment performed by the receiver device.

In an example, the receiver device obtains a second assessment result by performing clear channel assessment, and determines whether to send an assistance opening request according to the second assessment result and a second threshold value. In an example, in response to the second assessment result being greater than or equal to a threshold value, the assistance opening request is sent. In another example, in response to the second assessment result being less than or equal to the threshold value, the assistance opening request is not sent.

In this example, through a manner that the receiver device determines whether to actively send the assistance opening request according to a clear channel assessment result, after receiving the assistance opening request, the transmitter device determines to perform the LBT assessment on the unlicensed channel by using the second manner. The transmitter device selects the second manner according to indication of the receiver device, so that an operation of selecting the second manner conforms to a channel interference situation of the receiver device.

An example of the disclosure provides a method for accessing an unlicensed channel, applied to a receiver device. This receiver device is either a base station device or user equipment. The method includes:
sending assistance information to a transmitter device, so that the transmitter device determines an assessment manner according to the assistance information, where the assistance information includes an assistance terminating request, so that the transmitter device determines to perform LBT assessment on the unlicensed channel by using a first manner.

The first manner includes the transmitter device performing the LBT assessment to obtain a first assessment result.

In an implementation, the receiver device obtains a second assessment result by performing clear channel assessment, and determines whether to send the assistance terminating request according to the second assessment result and a second threshold value. In an example, when the second assessment result is less than or equal to a threshold value, the assistance terminating request is sent. In another example, when the second assessment result is greater than or equal to the threshold value, the assistance terminating request is not sent.

In this example, through a manner that the receiver device determines whether to actively send the assistance terminating request according to a clear channel assessment result, after receiving the assistance terminating request, the transmitter device determines to perform the LBT assessment on the unlicensed channel by using the first manner. The transmitter device selects the first manner according to indication of the receiver device, so that an operation of selecting the first manner conforms to a channel interference situation of the receiver device.

An example of the disclosure provides a method for accessing an unlicensed channel, applied to a receiver device. This receiver device is either a base station device or user equipment. The method includes the method shown in FIG. 3, and
the assistance information is used for representing information of an HARQ-ACK feedback result.

In the example of the disclosure, the above two examples may be used together, separately, or in combination. For example, a second manner is used when sending an assistance opening request, and a first manner is used when sending an assistance terminating request; and the solution may be, for example, used in the following scenarios: switching between two LBT manners. When being used separately, the two examples may be, for example, used in the following scenarios: directly assisting a receiver in determining an initial LBT manner during an initial stage.

An example of the disclosure provides an apparatus for accessing an unlicensed channel, applied to a transmitter device. This transmitter device is either a base station device or user equipment. The access apparatus is used for executing any of the previous method examples.

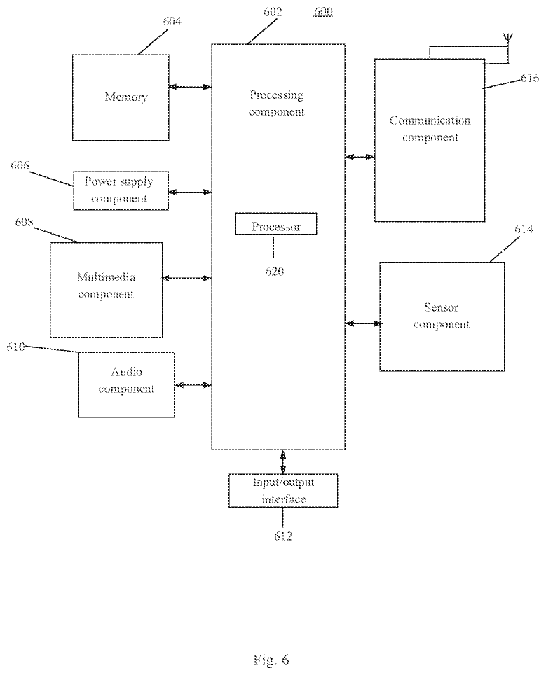

Referring to FIG. 4, FIG. 4 is a structural diagram of an apparatus for accessing an unlicensed channel shown according to an example. As shown in FIG. 4, the apparatus includes:
a first determining module 401, configured to determine an assessment manner of performing listen before talk (LBT) assessment on the unlicensed channel, where the assessment manner includes a first manner or a second manner, the first manner includes a transmitter device performing the LBT assessment to obtain a first assessment result, and the second manner includes the transmitter device performing the LBT assessment to obtain the first assessment result and acquiring a second assessment result of the LBT assessment performed by a receiver device; and
an assessing module 402, configured to assess the unlicensed channel according to the determined assessment manner.

An example of the disclosure provides an apparatus for accessing an unlicensed channel, applied to a transmitter device. This transmitter device is either a base station device or user equipment. The access apparatus is used for executing any of the previous method examples. The apparatus includes the apparatus shown in FIG. 4, and
a first determining module 401 is configured to determine an assessment manner of performing LBT assessment on the unlicensed channel by using the following method:
determining the assessment manner according to an HARQ-ACK feedback result of a receiver device.

In an implementation, determining the assessment manner according to the HARQ-ACK feedback result of the receiver device includes:
determining, in response to a proportion of NACK received within a first time interval being greater than or equal to a threshold value, to perform the LBT assessment on the unlicensed channel by using a second manner.

In an implementation, determining the assessment manner according to the HARQ-ACK feedback result of the receiver device includes:
determining, in response to a proportion of NACK received within a first time interval being less than or equal to a threshold value, to perform the LBT assessment on the unlicensed channel by using a first manner.

An example of the disclosure provides an apparatus for accessing an unlicensed channel, applied to a transmitter device. This transmitter device is either a base station device or user equipment. The access apparatus is used for executing any of the previous method examples. The apparatus includes the apparatus shown in FIG. 4, and
a first determining module 401 is configured to determine an assessment manner of performing LBT assessment on an unlicensed channel by using the following method:
determining, in response to receiving an assistance opening request of a receiver device, to perform the LBT assessment on the unlicensed channel by using a second manner.

An example of the disclosure provides an apparatus for accessing an unlicensed channel, applied to a transmitter device. This transmitter device is either a base station device or user equipment. The access apparatus is used for executing any of the previous method examples. The apparatus includes the apparatus shown in FIG. 4, and
a first determining module 401 is configured to determine an assessment manner of performing LBT assessment on an unlicensed channel by using the following method:
determining, in response to receiving an assistance terminating request sent by the receiver device, to perform the LBT assessment on the unlicensed channel by using the first manner.

An example of the disclosure provides an apparatus for accessing an unlicensed channel, applied to a transmitter device. This transmitter device is either a base station device or user equipment. The access apparatus is used for executing any of the previous method examples. The apparatus includes the apparatus shown in FIG. 4, and
a first determining module 401 is configured to determine an assessment manner of performing LBT assessment on the unlicensed channel by using the following method:
determining, in response to receiving a configuration signaling, the assessment manner of performing the LBT assessment on the unlicensed channel according to the configuration signaling.

An example of the disclosure provides an apparatus for accessing an unlicensed channel, applied to a transmitter device. This transmitter device is either a base station device or user equipment. The access apparatus is used for executing any of the previous method examples. The apparatus includes the apparatus shown in FIG. 4, and
a first determining module 401 is configured to determine an assessment manner of performing LBT assessment on the unlicensed channel by using the following method:
determining, in response to receiving a media access control (MAC) signaling or a radio resource control (RRC) signaling, an assessment manner of performing LBT assessment on the unlicensed channel by using a second manner according to preset fields of the MAC signaling or RRC signaling;
or,
determining, in response to receiving the MAC signaling or the RRC signaling, the assessment manner of performing the LBT assessment on the unlicensed channel by switching from a first manner to the second manner according to the preset fields of the MAC signaling or RRC signaling.

An example of the disclosure provides an apparatus for accessing an unlicensed channel, applied to a transmitter device. This transmitter device is either a base station device or user equipment. The access apparatus is used for executing any of the previous method examples. The apparatus includes the apparatus shown in FIG. 4, and
a first determining module 401 is configured to determine an assessment manner of performing LBT assessment on the unlicensed channel by using the following method:
determining, in response to receiving an MAC signaling or an RRC signaling, an assessment manner of performing LBT assessment on the unlicensed channel by using a first manner according to preset fields of the MAC signaling or RRC signaling; and
or,
determining, in response to receiving the MAC signaling or the RRC signaling, the assessment manner of performing the LBT assessment on the unlicensed channel by switching from a second manner to the first manner according to the preset fields of the MAC signaling or RRC signaling.

An example of the disclosure provides an apparatus for accessing an unlicensed channel, applied to a receiver device. This receiver device is either a base station device or user equipment. The access apparatus is used for executing any of the previous method examples. Referring to FIG. 5, FIG. 5 is a structural diagram of an apparatus for accessing an unlicensed channel shown according to an example. As shown in FIG. 5, the apparatus includes:
a sending module 501, configured to send assistance information to a transmitter device, so that the transmitter device determines an assessment manner according to the assistance information, where
the assessment manner is an assessment manner for assessing accessing the unlicensed channel; and
the assessment manner includes a first manner or a second manner, the first manner includes the transmitter device performing LBT assessment to obtain a first assessment result, and the second manner includes the transmitter device performing the LBT assessment to obtain the first assessment result and acquiring a second assessment result of the LBT assessment performed by the receiver device.

An example of the disclosure provides an apparatus for accessing an unlicensed channel, applied to a receiver device. This receiver device is either a base station device or user equipment. The access apparatus is used for executing any of the previous method examples. The apparatus includes the apparatus shown in FIG. 5, and
the assistance information includes an assistance opening request or an assistance terminating request.

An example of the disclosure provides an apparatus for accessing an unlicensed channel, applied to a receiver device. This receiver device is either a base station device or user equipment. The apparatus includes the apparatus shown in FIG. 5, and
the assistance information is used for representing information of an HARQ-ACK feedback result.

An example of the disclosure provides an apparatus for accessing an unlicensed channel, applied to a receiver device. This receiver device is either a base station device or user equipment. The access apparatus is used for executing any of the previous method examples. The apparatus includes the apparatus shown in FIG. 5, and further includes:
an assessing module, configured to obtain a second assessment result by performing clear channel assessment; and
a second determining module, configured to determine assistance information according to the second assessment result and a second threshold value.

An example of the disclosure provides a non-temporary computer-readable storage medium is provided, storing executable instructions, the executable instructions, when executed by a processor, implementing steps of the method for accessing the unlicensed channel.

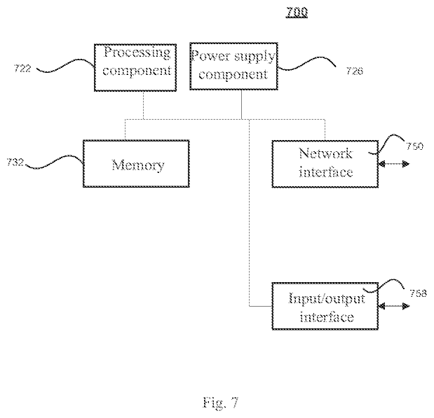

FIG. 6 is a block diagram of an apparatus 600 for accessing an unlicensed channel shown according to an example. For example, the apparatus 600 may be a mobile telephone, a computer, a digital broadcast terminal, a messaging device, a game console, a tablet device, a medical device, a fitness device, a personal digital assistant, and the like.

Referring to FIG. 6, the apparatus 600 may include one or more of the following components: a processing component 602, a memory 604, a power supply component 606, a multimedia component 608, an audio component 610, an input/output (I/O) interface 612, a sensor component 614, and a communication component 616.

The processing component 602 usually controls overall operation of the apparatus 600, such as operations associated with displaying, telephone calling, data communication, a camera operation and a record operation. The processing component 602 may include one or more processors 620 to execute an instruction, so as to complete all or part of steps of the above method. In addition, the processing component 602 may include one or more modules, so as to facilitate interaction between the processing component 602 and other components. For example, the processing component 602 may include a multimedia module, so as to facilitate interaction between the multimedia component 608 and the processing component 602.

The memory 604 is configured to store various types of data so as to support operations on the apparatus 600. Examples of these data include instructions of any application program or method used to be operated on the apparatus 600, contact data, telephone directory data, messages, pictures, videos, and the like. The memory 604 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 606 provides electric power for various components of the apparatus 600. The power supply component 606 may include a power management system, one or more power supplies, and other components associated with generating, managing and distributing electric power for the apparatus 600.

The multimedia component 608 includes a screen providing an output interface between the apparatus 600 and a user. In some examples, the screen may include a liquid crystal display (LCD) and a touch panel (TP). If the screen includes the touch panel, the screen may be implemented as a touch screen so as to receive an input signal from the user. The touch panel includes one or more touch sensors to sense touching, swiping and gestures on the touch panel. The touch sensor may not only sense a boundary of a touching or swiping action, but also detect duration and pressure related to the touching or swiping operation. In some examples, the multimedia component 608 includes a front camera and/or a back camera. When the apparatus 600 is in an operation mode, such as a shooting mode or a video mode, the front camera and/or the back camera may receive external multimedia data. Each front camera and each back camera may be a fixed optical lens system or have a focal length and optical zooming capability.

The audio component 610 is configured to output and/or input an audio signal. For example, the audio component 610 includes a microphone (MIC). When the apparatus 600 is in an operation mode, such as a call mode, a recording mode or a speech recognition mode, the microphone is configured to receive an external audio signal. The received audio signal may be further stored in the memory 604 or sent via the communication component 616. In some examples, the audio component 610 further includes a speaker for outputting the audio signal.

The I/O interface 612 provides an interface between the processing component 602 and a peripheral interface module, and the above peripheral interface module may be a keyboard, a click wheel, buttons, etc. These buttons may include but are not limited to: a home button, a volume button, a start button and a lock button.

The sensor component 614 includes one or more sensors for providing state evaluations of all aspects for the apparatus 600. For example, the sensor component 614 may detect an on/off state of the apparatus 600 and relative positioning of components, for example, the components are a display and a keypad of the apparatus 600. The sensor component 614 may further detect position change of the apparatus 600 or one component of the apparatus 600, whether there is contact between the user and the apparatus 600, azimuth or speed up/speed down of the apparatus 600, and temperature change of the apparatus 600. The sensor component 614 may include a proximity sensor, which is configured to detect existence of a nearby object without any physical contact. The sensor component 614 may further include an optical sensor, such as a CMOS or CCD image sensor, for use in an imaging application. In some examples, the sensor component 614 may further include an acceleration sensor, a gyroscope sensor, a magnetic sensor, a pressure sensor or a temperature sensor.

The communication component 616 is configured to facilitate wired or wireless communication between the apparatus 600 and other devices. The apparatus 600 may access a wireless network based on a communication standard, such as WiFi, 2G or 3G, or their combination. In one example, the communication component 616 receives a broadcast signal or broadcast related information from an external broadcast management system via a broadcast channel. In an example, the communication component 616 further includes a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the apparatus 600 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the above method.

In the example, a non-temporary computer-readable storage medium including instructions is further provided, such as a memory 604 including instructions. The above instructions may be executed by a processor 620 of the apparatus 600 so as to complete the above method. For example, the non-temporary computer-readable storage medium may be an ROM, a random access memory (RAM), a CD-ROM, a magnetic tape, a floppy disk, an optical data storage device and the like.

FIG. 7 is a block diagram of an apparatus 700 for accessing an unlicensed channel shown according to an example. For example, the apparatus 700 may be provided as a base station. Referring to FIG. 7, the apparatus 700 includes a processing component 722, which further includes one or more processors, and a memory resource represented by a memory 732, for storing instructions executable by the processing component 722, such as an application program. The application program stored in the memory 732 may include one or more modules, each of which corresponding to a set of instructions. In addition, the processing component 722 is configured to execute the instructions to execute the above method for accessing the unlicensed channel.

The apparatus 700 may further include a power supply component 726 configured to execute power management of the apparatus 700, a wired or wireless network interface 750 configured to connect the apparatus 700 to a network, and an input/output (I/O) interface 759. The apparatus 700 may operate an operating system stored in a memory 732, such as Windows Server™, Mac OS X™, Unix™, Linux™, FreeBSD™ or the like.

Those skilled in the art will easily figure out other implementation solutions of the examples of the disclosure after considering the specification and practicing the disclosure disclosed here. The present application intends to cover any transformation, usage or adaptive change of the examples of the disclosure, and these transformations, usages or adaptive changes conform to a general principle of the examples of the disclosure and include common general knowledge or conventional technical means in the technical field not disclosed by the disclosure. The specification and the examples are merely regarded as examples, and the true scope and spirit of the examples of the disclosure are indicated by the following claims.

It is to be understood that the examples of the disclosure are not limited to the exact structure that has been described above and shown in the accompanying drawings, and that various modifications and changes may be made without departing from the scope of the disclosure. The scope of the examples of the disclosure is limited merely by the appended claims.

According to a first aspect of an example of the disclosure, a method for accessing an unlicensed channel is provided, applied to a transmitter device, and including:
determining an assessment manner of performing listen before talk (LBT) assessment on the unlicensed channel, where the assessment manner includes a first manner or a second manner, the first manner includes a transmitter device performing the LBT assessment to obtain a first assessment result, and the second manner includes the transmitter device performing the LBT assessment to obtain the first assessment result and acquiring a second assessment result of the LBT assessment performed by a receiver device; and
assessing the unlicensed channel according to the determined assessment manner.

In an implementation, determining the assessment manner of performing the LBT assessment on the unlicensed channel includes:
determining the assessment manner according to an HARQ-ACK feedback result of the receiver device.

In an implementation, determining the assessment manner according to the HARQ-ACK feedback result of the receiver device includes:
determining, in response to a proportion of NACK received within a first time interval being greater than or equal to a threshold value, to perform the LBT assessment on the unlicensed channel by using the second manner.

In an implementation, determining the assessment manner according to the HARQ-ACK feedback result of the receiver device includes:
determining, in response to a proportion of NACK received within a first time interval being less than or equal to a threshold value, to perform the LBT assessment on the unlicensed channel by using the first manner.

In an implementation, determining the assessment manner of performing the LBT assessment on the unlicensed channel includes:
determining, in response to receiving an assistance opening request of the receiver device, to perform the LBT assessment on the unlicensed channel by using the second manner.

In an implementation, determining the assessment manner of performing the LBT assessment on the unlicensed channel includes:
determining, in response to receiving an assistance terminating request sent by the receiver device, to perform the LBT assessment on the unlicensed channel by using the first manner.

In an implementation, determining the assessment manner of performing the LBT assessment on the unlicensed channel includes:
determining, in response to receiving a configuration signaling, the assessment manner of performing the LBT assessment on the unlicensed channel according to the configuration signaling.

In an implementation, determining the assessment manner of performing the LBT assessment on the unlicensed channel includes:
determining, in response to receiving a media access control (MAC) signaling or a radio resource control (RRC) signaling, the assessment manner of performing the LBT assessment on the unlicensed channel by using the second manner according to preset fields of the MAC signaling or RRC signaling;
or,
determining, in response to receiving the MAC signaling or the RRC signaling, the assessment manner of performing the LBT assessment on the unlicensed channel by switching from the first manner to the second manner according to the preset fields of the MAC signaling or RRC signaling.

In an implementation, determining the assessment manner of performing the LBT assessment on the unlicensed channel includes:
determining, in response to receiving an MAC signaling or an RRC signaling, the assessment manner of performing the LBT assessment on the unlicensed channel by using the first manner according to preset fields of the MAC signaling or RRC signaling;
or,
determining, in response to receiving the MAC signaling or the RRC signaling, the assessment manner of performing the LBT assessment on the unlicensed channel by switching from the second manner to the first manner according to the preset fields of the MAC signaling or RRC signaling.

According to a second aspect of an example of the disclosure, a method for accessing an unlicensed channel is provided, applied to a receiver device, and including:
sending assistance information to a transmitter device, so that the transmitter device determines an assessment manner according to the assistance information, where
the assessment manner is an assessment manner for assessing accessing the unlicensed channel; and
the assessment manner includes a first manner or a second manner, the first manner includes the transmitter device performing LBT assessment to obtain a first assessment result, and the second manner includes the transmitter device performing the LBT assessment to obtain the first assessment result and acquiring a second assessment result of the LBT assessment performed by the receiver device.

In an implementation, the assistance information includes an assistance opening request or an assistance terminating request.

In an implementation, the assistance information is used for representing information of an HARQ-ACK feedback result.

In an implementation, the method includes:
obtaining the second assessment result by performing clear channel assessment; and
determining the assistance information according to the second assessment result and a second threshold value.

According to a third aspect of an example of the disclosure, an apparatus for accessing an unlicensed channel is provided, applied to a transmitter device, and including:
a determining module, configured to determine an assessment manner of performing listen before talk (LBT) assessment on the unlicensed channel, where the assessment manner includes a first manner or a second manner, the first manner includes a transmitter device performing the LBT assessment to obtain a first assessment result, and the second manner includes the transmitter device performing the LBT assessment to obtain the first assessment result and acquiring a second assessment result of the LBT assessment performed by a receiver device; and
an assessing module, configured to assess the unlicensed channel according to the determined assessment manner.

According to a fourth aspect of an example of the disclosure, an apparatus for accessing an unlicensed channel is provided, applied to a receiver device, and including:
a sending module, configured to send assistance information to a transmitter device, so that the transmitter device determines an assessment manner according to the assistance information, where
the assessment manner is an assessment manner for assessing accessing the unlicensed channel; and
the assessment manner includes a first manner or a second manner, the first manner includes the transmitter device performing LBT assessment to obtain a first assessment result, and the second manner includes the transmitter device performing the LBT assessment to obtain the first assessment result and acquiring a second assessment result of the LBT assessment performed by the receiver device.

According to a fifth aspect of an example of the disclosure, a transmitter device is provided, including:
a processor; and
a memory, configured to store executable instructions of the processor, where
the processor is configured to execute the executable instructions in the memory so as to implement steps of the method for accessing the unlicensed channel.

According to a sixth aspect of an example of the disclosure, a receiver device is provided, including:
a processor; and
a memory, configured to store executable instructions of the processor, where
the processor is configured to execute the executable instructions in the memory so as to implement steps of the method for accessing the unlicensed channel.

According to a seventh aspect of an example of the disclosure, a non-temporary computer-readable storage medium is provided, storing executable instructions, the executable instructions, when executed by a processor, implementing steps of the method for accessing the unlicensed channel.

### INDUSTRIAL APPLICABILITY

The transmitter device can assess the unlicensed channel by using different manners, that is, same can assess the unlicensed channel by using the first manner, and can also assess the unlicensed channel by using the second manner. Both manners have their own strengths, for example, the transmitter device can save signaling overheads when using the first manner, and can improve assessment accuracy of an interference level when using the second manner. The transmitter device switches between the two assessment manners, and can use different assessment manners in different application scenarios, so as to meet different assessment requirements.

1. A method for accessing an unlicensed channel, performed by a transmitter device, and comprising:
determining an assessment manner of performing a listen before talk (LBT) assessment on the unlicensed channel, wherein the assessment manner comprises a first manner or a second manner, the first manner comprises the transmitter device performing the LBT assessment to obtain a first assessment result, and the second manner comprises the transmitter device performing the LBT assessment to obtain the first assessment result and acquiring a second assessment result of the LBT assessment performed by a receiver device; and
assessing the unlicensed channel according to the determined assessment manner.

2. The method for accessing the unlicensed channel according to claim 1, wherein determining the assessment manner of performing the LBT assessment on the unlicensed channel comprises:
determining the assessment manner according to an HARQ-ACK feedback result of the receiver device.

3. The method for accessing the unlicensed channel according to claim 2, wherein determining the assessment manner according to the HARQ-ACK feedback result of the receiver device comprises:
determining a proportion of NACK received within a first time interval being greater than or equal to a threshold value; and
determining to perform the LBT assessment on the unlicensed channel by using the second manner.

4. The method for accessing the unlicensed channel according to claim 2, wherein determining the assessment manner according to the HARQ-ACK feedback result of the receiver device comprises:
determining a proportion of NACK received within a first time interval being less than or equal to a threshold value; and
determining to perform the LBT assessment on the unlicensed channel by using the first manner.

5. The method for accessing the unlicensed channel according to claim 1, wherein determining the assessment manner of performing the LBT assessment on the unlicensed channel comprises:
receiving an assistance opening request of the receiver device; and
determining to perform the LBT assessment on the unlicensed channel by using the second manner.

6. The method for accessing the unlicensed channel according to claim 1, wherein determining the assessment manner of performing the LBT assessment on the unlicensed channel comprises:
receiving an assistance terminating request sent by the receiver device; and
determining to perform the LBT assessment on the unlicensed channel by using the first manner.

7. The method for accessing the unlicensed channel according to claim 1, wherein determining the assessment manner of performing the LBT assessment on the unlicensed channel comprises:
receiving a configuration signaling; and
determining the assessment manner of performing the LBT assessment on the unlicensed channel according to the configuration signaling.

8. The method for accessing the unlicensed channel according to claim 1, wherein determining the assessment manner of performing the LBT assessment on the unlicensed channel comprises:
receiving a medium access control (MAC) signaling or a radio resource control (RRC) signaling; and
determining to perform the LBT assessment on the unlicensed channel by using the second manner according to preset fields of the MAC signaling or RRC signaling.

9. The method for accessing the unlicensed channel according to claim 1, wherein determining the assessment manner of performing the LBT assessment on the unlicensed channel comprises:
receiving an MAC signaling or an RRC signaling; and
determining to perform the LBT assessment on the unlicensed channel by using the first manner according to preset fields of the MAC signaling or RRC signaling.

10. A method for accessing an unlicensed channel, performed by a receiver device, and comprising:
sending assistance information to a transmitter device, the assistance information is configured to determine an assessment manner by the transmitter device according to the assistance information, wherein
the assessment manner is an assessment manner for assessing accessing the unlicensed channel; and
the assessment manner comprises a first manner or a second manner, the first manner comprises the transmitter device performing LBT assessment to obtain a first assessment result, and the second manner comprises the transmitter device performing the LBT assessment to obtain the first assessment result and acquiring a second assessment result of the LBT assessment performed by the receiver device.

11. The method for accessing the unlicensed channel according to claim 10, wherein
the assistance information comprises an assistance opening request or an assistance terminating request.

12. The method for accessing the unlicensed channel according to claim 10, wherein
the assistance information is configured to represent information of an HARQ-ACK feedback result.

13. The method for accessing the unlicensed channel according to claim 11, wherein
the method comprises:
obtaining the second assessment result by performing clear channel assessment; and
determining the assistance information according to the second assessment result and a second threshold value.

14. (canceled)

15. (canceled)

16. A transmitter device, comprising:
a processor; and
a memory, configured to store executable instructions of the processor, wherein
the processor is configured to:
determine an assessment manner of performing a listen before talk (LBT) assessment on an unlicensed channel, wherein the assessment manner comprises a first manner or a second manner, the first manner comprises the transmitter device performing the LBT assessment to obtain a first assessment result, and the second manner comprises the transmitter device performing the LBT assessment to obtain the first assessment result and acquiring a second assessment result of the LBT assessment performed by a receiver device; and
assess the unlicensed channel according to the determined assessment manner.

17. A receiver device, comprising:
a processor; and
a memory, configured to store executable instructions of the processor, wherein
the processor is configured to execute the executable instructions in the memory so as to implement steps of the method for accessing the unlicensed channel according to claim 10.

18. A non-transitory computer-readable storage medium, storing executable instructions, wherein the executable instructions, when executed by a processor, cause the processor to perform the method for accessing the unlicensed channel according to claim 1.

19. The method for accessing the unlicensed channel according to claim 1, wherein determining the assessment manner of performing the LBT assessment on the unlicensed channel comprises:
receiving a medium access control (MAC) signaling or a radio resource control (RRC) signaling; and
determining to perform the LBT assessment on the unlicensed channel by switching from the first manner to the second manner according to preset fields of the MAC signaling or RRC signaling.

20. The method for accessing the unlicensed channel according to claim 1, wherein determining the assessment manner of performing the LBT assessment on the unlicensed channel comprises:
receiving a medium access control (MAC) signaling or a radio resource control (RRC) signaling; and
determining to perform the LBT assessment on the unlicensed channel by switching from the second manner to the first manner according to preset fields of the MAC signaling or RRC signaling.

21. The method for accessing the unlicensed channel according to claim 11, wherein
the assistance information is configured to represent information of an HARQ-ACK feedback result.

22. A non-transitory computer-readable storage medium, storing executable instructions, wherein the executable instructions, when executed by a processor, cause the processor to perform the method for accessing the unlicensed channel according to claim 10.
